(19) United States
(12) Patent Application Publication
(10) Pub. No.: US 2019/0241478 A1
(43) Pub. Date: Aug. 8, 2019

(54) AMMONIUM SULFATE-CONTAINING GRANULATE, METHOD, AND SYSTEM FOR PRODUCING SAME

(71) Applicants: thyssenkrupp Industrial Solutions AG, Essen (DE); thyssenkrupp AG, Essen (DE)

(72) Inventors: Peter BANIK, Waltrop (DE); Dennis BOROWEC, Moers (DE); Jens MATHIAK, Castrop-Rauxel (DE); Daniel MIKAUTSCH, Dortmund (DE); Christian RENK, Dortmund (DE)

(73) Assignees: thyssenkrupp Industrial Solutions AG, Essen (DE); thyssenkrupp AG, Essen (DE)

(21) Appl. No.: 16/341,496

(22) PCT Filed: Oct. 12, 2017
(86) PCT No.: PCT/EP2017/075998

§ 371 Date: Apr. 12, 2019

(30) Foreign Application Priority Data
Oct. 20, 2016 (DE) 10 2016 220 648.6

(51) Int. Cl. C05C 7/02; C05C 3/00; B01J 2/16

(52) U.S. Cl. CPC C05C 7/02; C05D 9/02; B01J 2/16; C05C 3/005

(57) ABSTRACT

An ammonium-sulphate-containing fertiliser granulate including at least one metal salt as a granulation additive, which is a trace element and/or a granulation aid, and a sulphate of a metal selected from the group including Cu, Co, and Mo. A method is disclosed for the production of a fertiliser granulate in which the fertiliser granulate is produced by granulation in a fluidised-bed granulator, in which an aqueous composition containing at least the ammonium sulphate and at least one granulation additive is sprayed onto a fluidised bed of fluidised ammonium-sulphate-containing nuclei. Moreover, the granulation aid can contain at least one metal sulphate selected from the group comprising zinc sulphate, magnesium sulphate, manganese sulphate, iron sulphate or aluminium sulphate.

The present invention relates to an ammonium-sulphate-containing fertiliser comprising one or a plurality of trace elements in the form of metal salts and at least one further metal salt as a granulation aid, and a method for the production of a fertiliser granulate.

Ammonium sulphate finds a wide variety of uses. For example, ammonium sulphate is used as a fertiliser or fertiliser additive. Ammonium sulphate constitutes a source of both nitrogen and sulphur, which are important plant nutrients. There is a sulphur deficiency worldwide in many types of soil which can at least partially be compensated for by the selective addition of ammonium sulphate.

Numerous trace elements in the form of metal cations are required for plant growth and for the health of human beings as consumers. These trace elements can be added in a specified concentration to a fertiliser in the form of ammonium sulphate granulate and thus be made available to the soil, plants, and at the top of the food chain, to humans.

Several definitions will be provided below which are used in the technical field of fertiliser granules, to which the present invention relates.

Fertilisers—these are understood to be the main components of the granulate, which as a rule account for >95% of its dry matter.

Granulation additives—these are understood to be all components that are contained in fertilisers in small amounts, accounting as a rule for a total of <5% of the dry weight of the granulate, and have various functions.

Granulation aids—these are understood to be granulation additives whose function lies chiefly in improvement of the granulation capacity of the fertiliser, reduction of the amount of dust, and improvement of granulate properties (such as compressive strength, granulate structure and surface qualities).

Trace elements—these are understood to be granulation additives that are important for plant growth and can be integrated into the granulate in minimal amounts (e.g. concentrations in the ppm range). In the ideal case, they can have a supportive action as a granulation aid, but this is not their primary task.

The production of ammonium sulphate can take place in various ways. For example, ammonium sulphate can be formed by reacting ammonia with sulphuric acid. Industrially, ammonium sulphate is often crystallised from solutions which accumulate as byproducts, for example in coal furnaces or plants for the production of caprolactam. In the crystallisation of ammonium sulphate, mostly angular crystals are generated, which ordinarily have a diameter of 1 to 2 mm.

Ammonium sulphate is ordinarily not the only component of a fertiliser; rather, fertilisers comprise combinations of various plant nutrients (such as, for example, nitrogen, phosphorus, potassium or sulphur). Ammonium sulphate is therefore often mixed with granulated fertilisers for use in order to produce a balanced fertiliser mixture.

However, crystalline ammonium sulphate has several drawbacks that make its integration into granulated fertiliser mixtures difficult. On the one hand, the ammonium sulphate particles formed by crystallisation are relatively small, and on the other, the particles often vary considerably in size due to abrasion and dust formation. These properties make it difficult to produce physically homogenous fertiliser mixtures with ammonium sulphate. In the distribution of fertiliser mixtures, however, uniform mixing and particle size distribution of the individual components are essential. If the particle size distribution is too broad, this can also lead to mechanical problems in uniform application of the fertiliser mixture.

For these reasons, granulated fertilisers or fertiliser mixtures that can also be prepared only shortly before use by mixing of the individual components are being used with increasing frequency. Granulated ammonium sulphate is ideally spherical, and the individual particles of the granulate have a diameter, for example, of 2 to 4 mm. This size is based on urea granules, which are the most widely-used fertiliser worldwide.

Various methods for the production of granulated ammonium sulphate are known in the prior art.

U.S. Pat. No. 4,589,904 describes the granulation of ammonium sulphate in a drum granulator with a dryer connected downstream, wherein the solution is produced in a pre-neutraliser.

US 2012/0231277 relates to the production of agglomerated granules by fluidised-bed or spouted-bed granulation. For this purpose, granulation nuclei that have first been produced separately are sprayed with an ammonium-sulphate-containing solution and then dried.

A problem in the granulation of ammonium sulphate is the production of dust, which is understood to refer to particles with a diameter of less than 0.5 mm. The production of dust can essentially be attributed to three sources. First, the respective nozzles that spray the material to be granulated produce drops with a specified distribution of diameters, with some of the finest drops solidifying before they strike the ammonium sulphate particles, such that the dust formed in this manner leaves the granulator together with the exhaust air. Moreover, abrasion of the granulate due to movements and collisions of the particles is also to be mentioned as a source of dust, for example in a fluidised bed, wherein the amount of accumulating dust essentially depends on the mechanical properties of the granulate. Finally, the third source to be noted is the dust generated by mechanical crushing of granulate particles being too large, which in the methods and plants according to the prior art is ordinarily directly returned to the granulator.

For this reason, granulation additives are often used as a granulation aid in order to reduce this dust formation. The addition of these additives causes the granulate particles and more particularly their surface to remain plastic, such that as a result of their rolling movements and collisions, round particles with a smooth surface and good mechanical stability are predominantly obtained. The granulate obtained in this manner therefore shows high compressive and impact strength, a low tendency towards dust formation by abrasion, and in addition, only a slight clumping tendency even during prolonged storage. However, corresponding granulation additives are used not only in fluidised-bed granulation, but also in other methods, such as, for example, spray crystallisation or drum granulation.

Various methods of preventing or reducing dust formation have been described in the prior art. Wang et al. (Particuology 11 (2013), 483-489) describe the use of calcium carbonate or silicon dioxide as an additive in the ammonium sulphate solution to be granulated, wherein the respective additive must be used in a relatively large amount in order to obtain a satisfactory granulation result. As these two additives are practically insoluble in water and form a suspension, they can only be used as micro- or nanoparticles, which in turn constitutes a considerable cost factor in obtaining them. On the other hand, particles that are too coarse can damage the pump and obstruct the spray nozzles.

However, the methods and devices for the granulation of ammonium sulphate are not satisfactory in every respect, and there is a need for improved methods and devices.

U.S. Pat. No. 8,974,763 B1 describes a method for the production of a granulate in which, in a granulator, aluminium sulphate Al₂(SO₄)₃ is sprayed as an additive onto a bed of ammonium sulphate particles. It has been found that when aluminium sulphate is added as an additive that is readily soluble in water, the ammonium sulphate can be granulated with significantly lower dust formation. At the same time, the particle hardness (compressive strength) is substantially increased even by using only a small amount of this additive. This makes it possible to obtain a higher product fraction meeting specifications, which allows the method to be carried out more economically than the methods previously described in the prior art.

WO 89/04291 A1 describes a method for the production of a granulate in which ammonium sulphate is first produced in a tube reactor from ammonia and sulphuric acid and a slurry of this ammonium sulphate is then applied to a bed of fine-grained recycled ammonium sulphate. It is then granulated in the presence of a granulation aid, and the resulting product is dried, screened and cooled. Conventional rotary granulators can be used for granulate production. Aluminium sulphate can be used as a granulation aid.

Aluminium salts are currently suspected to be harmful to health. For this reason, efforts are being made to find suitable substances for replacing aluminium sulphate.

The object of the present invention is to provide an improved ammonium-sulphate-containing granulate.

This object is achieved by means of a granulate according to the invention of the above type with the features of claim 1.

The solution according to the invention is based on the concept that it is appropriate because of the possible harmful action of aluminium sulphate on health to reduce the aluminium content in the fertiliser granulate by using alternative granulation aids, wherein at the same time, the fertiliser is enriched with additional trace elements that promote plant growth.

According to the invention, a sulphate of a metal selected from the group comprising Cu, Co, and Mo is used as a granulation additive.

If the fertiliser granulate according to the invention contains a copper sulphate as a granulation additive, this may be used for example in the form of CuSO₄.5H₂O.

A preferred improvement of the invention provides that the fertiliser granulate further comprises elemental sulphur and/or a calcium salt. More particularly, the elemental sulphur and/or the calcium salt are preferably contained as finely-ground solid.

The fertiliser granulate according to the invention preferably further contains at least one metal sulphate selected from the group comprising zinc sulphate, magnesium sulphate, manganese sulphate, iron sulphate or aluminium sulphate, wherein this metal sulphate can also be used as a granulation aid and wherein it is also particularly advantageous for the cation of this metal sulphate to be suitable as a trace element, promote plant growth and also be important for human nutrition.

The granulation additive according to the invention is preferably contained in the granulate in an amount of 0.5 to 2.5% by weight with respect to the total weight of the dry granulated product.

Moreover, at least one metal sulphate selected from the group comprising zinc sulphate, magnesium sulphate, manganese sulphate, iron sulphate or aluminium sulphate is preferably present in the granulate in an amount of 0.5 to 2.5% by weight with respect to the total weight of the dry granulated product.

It is preferable for the entire amount of all of the above substances (metal sulphates) used as granulation additives to be contained in the granulate in an amount of 0.5 to 2.5% by weight with respect to the total weight of the dry granulated product.

A further subject matter of the present invention is a method for the production of a fertiliser granulate, more particularly of the above-mentioned type, by granulation in a fluidised-bed granulator, wherein an aqueous composition containing at least the ammonium sulphate and at least one granulation additive and/or granulation aid and/or trace element is sprayed onto a fluidised bed of fluidised ammonium-sulphate-containing nuclei.

As a granulation additive in the method according to the invention, a sulphate of a metal selected from the group comprising Cu, Co, and Mo may be used. In addition to the above-mentioned sulphates, or alternatively thereto, at least one metal sulphate selected from the group comprising zinc sulphate, magnesium sulphate, manganese sulphate, iron sulphate or aluminium sulphate may also be used as a granulation aid.

In tests conducted in connection with the present invention, granulation aids have been found to be advantageous in which iron sulphate partially replaces the aluminium sulphate, which is questionable because of its effects on health. In this case, a considerable content of the aluminium sulphate can be replaced by iron sulphate, wherein the advantageous properties of the aluminium sulphate as a granulation aid are retained, more particularly the low tendency toward dust formation, the relatively high granule hardness and the high bulk density. It has been found in this case that mixtures of iron sulphate and aluminium sulphate as a granulation aid with a content of 50% by weight or less of iron sulphate and a content of 50% by weight or more of aluminium sulphate are particularly suitable. If a higher content of iron sulphate is selected, however, the strength of the granulate decreases somewhat and the dust formation rate also increases somewhat. For this reason, if applicable, a compromise must be found between the granulate properties on the one hand and the medical acceptability of the content of aluminium sulphate on the other.

According to a preferred improvement of the method according to the invention, a first composition containing at least one granulation additive in an aqueous solution and a second composition containing ammonium sulphate in an aqueous solution are first produced separately, these two solutions are then mixed with each other and the solution mixture is sprayed in the fluidised-bed granulator.

In order to set a specified solution concentration, for example, additional water can be added to the solution mixture before spraying in the fluidised-bed granulator. For example, this water can be supplied via a separate line to a mixing device to which the above-mentioned first composition and/or the above-mentioned second composition can also be supplied.

According to a preferred improvement of the above-mentioned method variant, for example, it is also possible to further add ammonium sulphate as a solid to the solution mixture before spraying in order to arrive at a specified concentration and a specified mixing ratio. This solid ammonium sulphate can for example be supplied via a separate line to a mixing device, to which the above-mentioned first composition and/or the above-mentioned second composition can also be supplied.

According to an improvement of the invention, it is also possible, for example in use of more than one metal sulphate as granulation aid, to first prepare separate aqueous solutions of each metal sulphate and the ammonium sulphate respectively and then combine these to obtain a specified mixing ratio, such that in this variant, it is also possible to first separately prepare three or more aqueous solutions and then produce one solution mixture from them which is sprayed into the fluidised-bed granulator.

In a preferred improvement of the method according to the invention, it is provided that the aqueous composition is sprayed from below into the fluidised-bed granulator and/or the fluidised bed.

It was found in tests in connection with the present invention that granulates can more particularly be produced with better properties by using an increased spray rate, wherein for example there is less tendency for dust to form. For this reason, the aqueous composition is preferably sprayed through nozzles at a spray rate of at least approx. 150 ml/min per nozzle.

Granules preferably comprise particles which are uniformly formed and have a homogeneous composition, wherein their quality and physical behaviour are known to the person skilled in the art. The particles of a granulate may be of different sizes, wherein the breadth of the particle size distribution constitutes a criterion for the quality of a granulate. The granulate according to the invention preferably has a narrow particle size distribution, wherein the largest and the smallest particle diameters preferably differ from each other by at most 10 mm, and more preferably at most 8 mm, at most 6 mm, at most 4 mm, at most 3 mm or at most 2 mm.

In a preferred embodiment, the granules according to the invention have a size in the range of 2 to 5 mm, more preferably in the range of 2 to 4.5 mm, even more preferably in the range of 2 to 4 mm and most preferably in the range of 2.5 to 4 mm.

In the production of a fertiliser granulate according to the invention, a composition comprising the granulation additives and ammonium sulphate is produced. The composition preferably also comprises water. Preferably, ammonium sulphate, granulation additives and water are mixed with one another in a mixing device. Particularly preferably, a first composition of ammonium sulphate and water and a second composition of granulation additives and water are used, with these compositions being mixed in a liquid state with each other in a corresponding ratio.

In a preferred embodiment, the content of ammonium sulphate in the composition is in the range of 30% by weight to at most a saturated solution, approx. 50% by weight, more preferably in the range of 31 to 49% by weight, in the range of 32 to 48% by weight, in the range of 33 to 47% by weight, in the range of 34 to 46% by weight or in the range of 35 to 45% by weight, in each case with respect to the total weight of the composition, and always below the temperature-dependent crystallisation limit.

In a preferred embodiment, the content of pure granulation additive in the solid components of the composition is in the range of 0.5 to 2.5% by weight, and more preferably in the range of 0.55 to 2.3% by weight, in the range of 0.6 to 2.1% by weight, in the range of 0.65 to 1.9% by weight, in the range of 0.7 to 1.7% by weight, in the range of 0.75 to 1.5% by weight, in the range of 0.8 to 1.3% by weight, in the range of 0.85 to 1.2% by weight or in the range of 0.9 to 1.1% by weight, in each case with respect to the total weight of the dry granulated product.

In another preferred embodiment, the content of pure granulation additive in the composition is at most 2.5% by weight, and more preferably at most 2.3% by weight, at most 2.1% by weight, at most 1.9% by weight, at most 1.7% by weight, at most 1.5% by weight, at most 1.3% by weight, at most 1.2% by weight, at most 1.1% by weight or at most 1.0% by weight, in each case with respect to the total weight of the dry granulated product.

The composition is preferably in the form of a mixture, wherein the mixture can for example be in the form of a solution.

Granulation of the composition can take place according to conventional methods known to the person skilled in the art, for example by means of spray crystallisation (prilling), drum granulation, crystallisation or fluidised-bed granulation. Granulation of the composition preferably takes place within the framework of the present invention by fluidised-bed granulation.

Production of the nuclei is preferably carried out by drying of the solidifying droplets of the composition, but can also take place by abrasion of already present and solidified granulate particles. By wetting of such granulate particles with further droplets, the particles grow and preferably form a homogeneous granulate.

In a preferred embodiment, granulation takes place by fluidised-bed granulation comprising the following steps:
provision of ammonium-sulphate-containing nuclei;
fluidising of the ammonium-sulphate-containing nuclei in the fluidised bed and
spraying of the composition provided as an aqueous solution containing ammonium sulphate and at least one granulation additive onto the nuclei.

In the above-mentioned preferred variant of the method according to the invention, ammonium-sulphate-containing nuclei are provided. The nuclei are preferably produced by screening or breaking of granulated ammonium sulphate as oversized particles.

The nuclei according to the invention preferably show a narrow size distribution, wherein the largest and the smallest nucleus diameter preferably differ from each other by at most 4 mm, more preferably at most 2 mm, at most 1 mm or at most 0.5 mm. Methods for the determination of a nucleus diameter are known to the person skilled in the art.

In a preferred embodiment, the diameter of the ammonium-sulphate-containing nuclei is in the range of 0.1 to 4.0 mm, more preferably in the range of 0.1 to 2.0 mm and most preferably in the range of 0.5 to 2.0 mm.

The ammonium-sulphate-containing nuclei are preferably fluidised in a fluidised bed. A fluidised bed is suitable for a large number of engineering processes for the treatment of solids and liquids, and its structure is known to the person skilled in the art. The fluidised bed according to the invention is preferably composed of the ammonium-sulphate-containing nuclei. A fluid preferably flows through the fluidised bed. The ammonium-sulphate-containing nuclei are preferably brought into a fluidised state by means of an upward flow of the fluid. This produces a fluid-like state of the nuclei that is also referred to as a “fluidised bed”. The fluid preferably contains air.

The so-called superficial velocity of the fluid used for fluidising of the ammonium-sulphate-containing nuclei is preferably in the range of 1-5 m/s, and more preferably in the range of 1.5-4.5 m/s, in the range of 2-4 m/s or in the range of 2.5-3.5 m/s.

The temperature of the fluidised bed is preferably in the range of 50° C. to approx. 120° C., and more preferably in the range of 60° C. to 90° C. or in the range of 70° C. to 80° C. The fluid is heated accordingly in order to set the fluidised bed temperature.

In the method according to the invention, the composition previously prepared as an aqueous solution in the desired mixing ratio is preferably sprayed onto the ammonium-sulphate-containing nuclei. In this process, the droplets formed in spraying of the composition are preferably conveyed into the fluidised bed of fluidised, ammonium-sulphate-containing nuclei. On reaching the fluidised bed, a fluid, preferably air, preferably flows through the droplets from below in an upward direction, wherein the fluid causes the droplets to dry and predominantly solidify on the nuclei, where they contribute to the growth of the nuclei.

Spraying of the composition preferably takes place within the fluidised bed, so that droplets formed during spraying are sprayed into the fluidised bed from below in an upward direction, which causes the sprayed composition to be conveyed onto the particles in the fluidised bed and dried.

In a preferred embodiment, spraying of the composition prepared as an aqueous solution takes place through nozzles, wherein through each nozzle at least 150 ml of the composition is sprayed per minute, and more preferably at least 250 ml per minute, at least 500 ml per minute, at least 1000 ml per minute, at least 1500 ml per minute or at least 2000 ml per minute.

Air is preferably used for spraying of the composition. There is preferably a slight negative pressure in the granulator above the fluidised bed. The negative pressure is preferably at most 10 mbar, more preferably at most 5 mbar or at most 2 mbar.

The flow rate of the air used for spraying of the composition through each jet is preferably in the range of 10 to 200 m³ per hour, and more preferably in the range of 20 to 180 m³ per hour, in the range of 40 to 160 m³ per hour, in the range of 60 to 140 m³ per hour or in the range of 80 to 120 m³ per hour.

The droplets preferably wet the ammonium-sulphate-containing nuclei or the already present, already solidified granulate particles so that they grow uniformly and form a homogeneous granulate.

In a preferred embodiment, the granulate particles leave the fluidised bed and are preferably conveyed to a sorting device. Suitable measures for conveying granulate particles from a fluidised bed to a further device are known to the person skilled in the art. For example, by using specially configured distribution plates, the granulate particles in a fluidised state can be caused to move not only vertically, but also horizontally, thus gradually leaving the fluidised bed.

In a preferred embodiment, at least a portion of the air used for fluidisation is cleaned in a purification stage as exhaust air. After flowing through the fluidised bed, the air is preferably drawn off above the fluidised bed and supplied to the purification stage. The air is preferably cleaned in the purification stage, i.e. more particularly depleted of solid particles and droplets. The purification stage is preferably a wet scrubber.

In a preferred embodiment, the granules are divided into at least three fractions after their production, wherein
one fraction (F₁) contains particles of the desired target size,
one fraction (F₂) contains particles of a size greater than the desired target size, and
one fraction (F₃) contains particles of a size less than the desired target size.

The fraction (F₁) containing particles of the desired target size is preferably further processed or packaged after leaving the fluidised bed.

The fraction (F₂) containing particles of a size greater than the desired target size is preferably supplied to a crushing device, which is preferably configured to crush granulate particles. The particles of fraction (F₂) are preferably crushed in the crushing device and the crushed particles are preferably recycled to the fluidised bed.

The fraction (F₃) containing particles of a size less than the desired target size is preferably recycled to the fluidised bed as nuclei for further growth.

In a preferred embodiment, the finished granules comprise at least 95% by weight of the sprayed amount of ammonium sulphate and granulation aid, more preferably at least 95.5% by weight, at least 96% by weight, and more preferably at least 96.5% by weight, at least 97% by weight, at least 97.5% by weight or at least 98% by weight.

In a preferred embodiment, the amount of ammonium sulphate and granulation aid which do not contribute to the weight of the finished granules and for example form dust is at most 10% by weight, more preferably at most 9% by weight, at most 8% by weight, at most 7% by weight, at most 6% by weight, at most 5% by weight, at most 4% by weight, at most 3% by weight, at most 2% by weight or at most 1% by weight, in each case with respect to the total dry weight of sprayed ammonium sulphate and granulation additives.

A further aspect of the invention relates to a granulate comprising ammonium sulphate and at least one granulation aid and/or trace element, wherein all of the particles of the granulate have a comparable composition and wherein the content of pure granulation aids and/or trace elements in the granulate is in the range of 0.5 to 2.5% by weight.

Within the meaning of the present invention, a comparable composition is understood to mean that the substance amounts of the individual components of the granulate according to the invention in the individual granulate particles differ by at most 2% of the average value of the substance amounts of the respective components in the entire granulate, and more preferably at most 1.5% or at most 1%. Methods for determining the substance amounts of a granulate are known to the person skilled in the art.

In a preferred embodiment, the content of ammonium sulphate in the granulate is at least 97.5% by weight, and more preferably at least 98% by weight, at least 98.5% by weight, or at least 99% by weight, in each case with respect to the total weight of the granulate.

In a further preferred embodiment, the content of pure granulation additives in the granulate is in the range of 0.5 to 2.5% by weight, and more preferably in the range of 0.6 to 2% by weight, in the range of 0.7 to 1.5% by weight, or in the range of 0.8 to 1.0% by weight, in each case with respect to the total weight of the granulate.

The granulate can optionally comprise further components. For example, the particulate composition contains water as residual moisture. The content of water in the granulate is preferably at most 1.0% by weight, and more preferably at most 0.8% by weight, at most 0.6% by weight, at most 0.4% by weight, or at most 0.2% by weight, in each case with respect to the total weight of the granulate.

Residual moisture is understood according to the present invention to refer to the water content (without water of crystallisation, only free moisture) of the granulated fertiliser that remains in the porous structure of the granulate particles even after drying. The residual moisture influences the shelf life of the product and the possible occurrence of clumping.

A further aspect of the invention relates to a device for the production of granulates comprising ammonium sulphate, wherein the device comprises the following components, which are at least temporarily in operative connection with one another:
(A) A mixing device, configured for the production of a composition comprising ammonium sulphate and at least one granulation additive of the above-mentioned type;
(B) a spraying device with a fluidised bed arranged downstream of the mixing device, configured for spraying of the composition produced in the mixing device; and
(C) a fluidised-bed granulator, configured for the production of the granulate.

All of the preferred embodiments described above in connection with the method according to the invention also apply analogously to the device according to the invention.

The components of the device according to the invention are in operative connection to one another, i.e. are connected to one another by suitable pipelines, etc. in a manner that ensures the general functionality of the device. The measures required for this are known to the person skilled in the art.

The mixing device according to the invention is preferably configured for the production of a composition comprising ammonium sulphate and at least one granulation additive. The structure and functioning of such a mixing device are known to the person skilled in the art.

The composition produced in the mixing device according to the invention is preferably sprayed in the spraying device. The spraying device is preferably arranged within the fluidised bed and sprays the composition from below in an upward direction onto the fluidised bed. The spraying device is configured such that the droplets formed on spraying have a narrow size distribution and are uniformly distributed.

The fluidised bed is preferably configured so as to fluidise the ammonium sulphate nuclei and the forming granulate particles.

In a preferred embodiment, the device comprises the following additional components that are operatively connected to the device:
(D) a dividing device arranged downstream of the fluidised bed, configured to divide the granules into fractions of differing particle size; and/or
(E) a purification stage, configured to purify the air used for fluidising.

The dividing device is preferably arranged downstream of the fluidised bed and configured to divide the granules into fractions of differing particle size. In this case, after leaving the fluidised bed, particles having the desired target size are preferably further processed or packaged. Particles having a size greater than the desired target size, and in some cases also a smaller portion of the product flow, are preferably supplied to a crushing device, where they are crushed. The crushed particles are preferably recycled to the fluidised bed as nuclei. Particles having a size less than the desired target size are recycled to the fluidised bed as nuclei.

The purification stage is preferably configured so as to purify the air that has flowed through the fluidised bed, i.e., more particularly to deplete it of solid particles and droplets. The purification stage is preferably a wet scrubber.

A further subject matter of the present invention is a system for the production of a fertiliser granulate based on ammonium sulphate, more particularly according to a method of the above-mentioned type, comprising a fluidised-bed granulator to which process air is supplied via a line and to which a solution containing ammonium sulphate and granulation additives is supplied, preferably via a pump, with the solution being blown into the fluidised-bed granulator via a spray nozzle, wherein the system comprises at least two separate vessels, wherein a first vessel receives a first solution containing granulation additives in water and a second vessel receives a solution containing ammonium sulphate in water, and wherein the two vessels are connected to each other or to a further vessel via a line and at least one of the vessels or the further vessel is/are directly or indirectly operatively connected to the fluidised-bed granulator via a line.

In the following, the present invention is explained in further detail by means of examples with reference to the attached drawing. The figures are as follows:

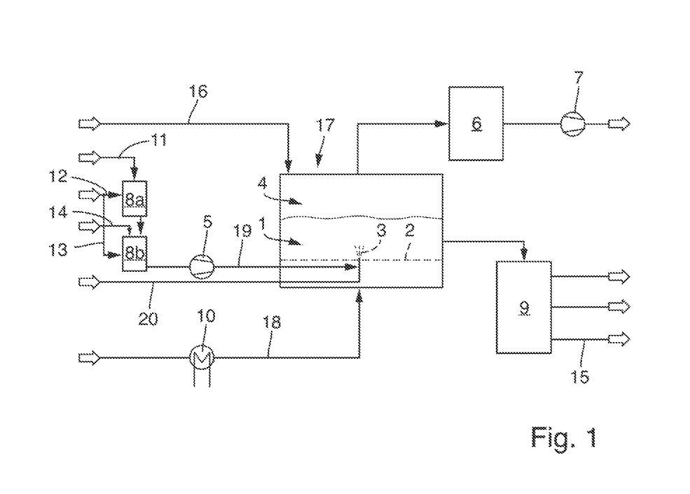

FIG. 1 is a flow chart of an exemplary granulation system that was used for the production of a fertiliser granulate according to the invention.

A possible example of the present invention is explained in further detail in the following with reference to FIG. 1. The FIGURE shows a flowchart of an exemplary granulation system that was used for the production of fertiliser granules according to the invention. This is a so-called fluidised-bed granulator 17. In this system, the air used for fluidisation is drawn from the environment, and it then flows via the line 18 and a distributor plate 2 into the process chamber 1. Before entering the process chamber, the air passes through an electric air heater 10. In the process chamber 1 is a spray nozzle 3 (an external mixing two-fluid nozzle with a cleaning needle), which is built-in in the “bottom-spray” configuration and sprays the solution vertically upward in parallel flow to the fluidisation air. The spray nozzle 3 is supplied via the line 20 with compressed air.

The spray solution is prepared batchwise in vessels 8. Granulation additives are dissolved in a first vessel 8a. The granulation additives are supplied to this first vessel 8a via a line 11. Water 12 is supplied to this first vessel 8a via a further line.

The ammonium sulphate solution is prepared in a second vessel 8b. On the one hand, water is supplied to this second vessel 8b via a branch line 13 connected to the line 12, and on the other, the ammonium sulphate (AS) is fed into the second vessel 8a via a further line 14. The corresponding amount of additive solution is metered from the first vessel 8a into the second vessel 8b together with the AS solution. The solution is homogenised using an agitator and preheated to the process temperature. The solution is then conveyed via a pump 5 through the line 19 into the fluidised-bed granulator 17. Above the process chamber 1 there is an expansion chamber 4 which has a larger device cross-section than the process chamber 1. The enlarged cross-section lowers the air speed and thus reduces the discharge of small particles from the system. The exhaust air is fed into an external purification stage 6 and is depleted of discharged particles there. A blower 7 is located downstream of the purification stage such that the entire system is operated in suction mode (negative pressure). The removed granulate is classified using a screening tower 9 into the 3 fractions of oversized particles (>4 mm), product (2-4 mm) and undersized particles (<2 mm). The screened-off undersized particles (fine particles) are recycled via the lines 15, 16 and fed into the granulator together with additional nucleus material.

The entire process is operated and monitored by means of a programmable logic controller (PLC). All relevant data are displayed on a PC in a real-time flowchart and stored with defined timing. Control of the fluidisation air flow and the air heater performance is carried out automatically, wherein the desired volume flow and supply air temperature are predetermined. The sprayed-in mass flow is controlled via the pump 5.

Examples Using Granulation Aids of Different Compositions:

Several definitions used in the present application are listed below.

Granule hardness: The hardness of the granules produced was measured using a Texture Analyser from Stable Micro Systems Ltd. For determination of granule hardness, in all cases, granules having a particle size between 2.5 and 2.8 mm that had been separated from the other samples by means of a screening unit were used. Granule hardness was determined from the recorded force displacement curve by means of a specified macro. In this context, granule hardness is defined as the maximum force [N] a particle can absorb before it breaks. In order to improve statistical certainty, at least 30 particles were measured for each sample selected for measurement of granule hardness. The mean value, standard deviation, and maximum and minimum values were then determined from the at least 30 measured values.

Particle size distribution: A so-called CAMSIZER XT® from Retsch Technology, which is based on an optical method, was used for measurement of particle size distribution. The particles are conveyed via a channel into a free-fall device. The particles dispersed in this manner fall through the measuring plane, where they pass by two LED strobe light sources. The shadow projections of the granules are recorded by two digital cameras. The cameras differ in their resolution such that one camera records the smaller and one the larger particles. The raw data are automatically evaluated by software and the distribution times are calculated in real time.

Residual moisture determination: The residual moisture of all of the samples was determined. For this purpose, a weighed sample was stored overnight on a small dish at 100° C. in a drying oven, and the weight of the sample was again determined after drying. Using the following formula, the measured values can be used to calculate the residual moisture content (RF) in percent with respect to the wet sample. A double determination was carried out for each sample in every case.

RF[%]=m_{wet}−m_{dry}/m_{wet}−m_{dish}

Bulk density: The bulk density of each end product was determined. For this purpose, a beaker having a specified volume V₀ was filled with the product, and the mass was determined. According to the following formula, the mass of the sample with respect to volume gives the bulk density of the sample.

ρ_{bulk}=mₛₐₘₚₗₑ/V₀

Substances used: The ammonium sulphate required for granulation was provided as a fine crystalline substance. A 40% by weight solution was produced with demineralised water.

All of the granulation aids were obtained from the firm Carl Roth GmbH+Co. KG.

In a series of tests, both trace elements as granulation additives composed of only one substance respectively, specifically copper sulphate pentahydrate, zinc sulphate heptahydrate and iron(II)sulphate heptahydrate, and combinations of iron sulphate and aluminium sulphate in which the aluminium sulphate was partially replaced in various amounts by iron sulphate were investigated. The additive contents are expressed with respect to sulphates free of water of crystallisation in all cases.

The test results are given in Table 1 below.

TABLE 1

| | | | | Aluminium | Aluminium | Aluminium |
|---|---|---|---|---|---|---|
| | | | | sulphate/iron | sulphate/iron | sulphate/iron |
| Granulation | Zinc | Copper | Iron | sulphate | sulphate | sulphate |
| aid | sulphate | sulphate | sulphate | 3:1 | 1:1 | 1:3 |
| Spray | 6 | 6 | 6 | 6 | 6 | 6 |
| duration (h) | | | | | | |
| Water | 60 | 60 | 60 | 60 | 60 | 60 |
| content in | | | | | | |
| solution (%) | | | | | | |
| Provided AS | 5 | 5 | 5 | 5 | 5 | 5 |
| (kg) | | | | | | |
| Bed height | 0.21 | 0.21 | 0.21 | 0.21 | 0.21 | 0.21 |
| (m) | | | | | | |
| Fluid air | 215 | 215 | 215 | 215 | 215 | 215 |
| stream | | | | | | |
| (m³/h) | | | | | | |
| Process | <100 | <100 | <100 | <100 | <100 | <100 |
| temperature | | | | | | |
| (° C.) | | | | | | |
| Granule | >20 | >15 | >25 | >25 | >20 | >10 |
| hardness (N) | | | | | | |
| Residual | <0.5 | <0.5 | <0.5 | <0.5 | <0.5 | >1 |
| moisture (%) | | | | | | |

The granule hardness decreases with increasing iron sulphate content, which is particularly noticeable when the iron sulphate content is greater than 50%. For copper and zinc, the hardnesses were within an acceptable range.

In most cases, residual moisture was less than 0.5%.

### LIST OF REFERENCE NOS

1 Process chamber
2 Distributor plate
3 Spray nozzle
4 Expansion chamber
5 Pump
6 Purification stage
7 Blower
8a First vessel
8b Second vessel
9 Screening unit
10 Air heater
11 Line for addition of additives
12 Water supply line
13 Water supply line
14 Line for addition of ammonium sulphate
15 Line for recycling the fine particles
16 Line for recycling the fine particles
17 Granulator
18 Air line
19 Line for solution to the granulator
20 Compressed air line

1.-18. (canceled)

19. An ammonium-sulphate-containing fertiliser granulate, comprising:
at least one metal salt granulation additive; and
wherein the granulate contains a granulation additive in the form of a sulphate of a metal selected from the group comprising Cu, Co, and Mo.

20. The ammonium-sulphate-containing fertiliser granulate of claim 19, wherein the granulate contains the granulation additive in an amount customary for trace elements.

21. The ammonium-sulphate-containing fertiliser granulate of claim 20, wherein the amount is in the ppm range.

22. The ammonium-sulphate-containing fertiliser granulate of claim 19, wherein the granulate contains CuSO₄.5H₂O as a trace element.

23. The ammonium-sulphate-containing fertiliser granulate of claim 19, wherein the granulate further comprises elemental sulphur and/or a calcium salt.

24. The ammonium-sulphate-containing fertiliser granulate of claim 23, wherein the elemental sulphur and/or the calcium salt are contained as finely-ground solid.

25. The ammonium-sulphate-containing fertiliser granulate of claim 19, wherein the granulate further contains at least one metal sulphate selected from the group comprising zinc sulphate, magnesium sulphate, manganese sulphate, iron sulphate or aluminium sulphate as a granulation aid.

26. The ammonium-sulphate-containing fertiliser granulate of claim 19, wherein the granulation additive is contained in the granulate in an amount of 0.5 to 2.5% by weight.

27. The ammonium-sulphate-containing fertiliser granulate of claim 26, wherein the metal sulphate is contained in the granulate in an amount of 0.5 to 2.5% by weight.

28. A method for the production of a fertiliser granulate, comprising:
granulating the fertiliser granulate in a fluidised-bed granulator, in which an aqueous composition containing at least ammonium sulphate and at least one granulation additive and/or trace element and/or granulation aid is sprayed onto a fluidised bed of fluidised ammonium-sulphate-containing nuclei, wherein the granulation additive contains a sulphate of a metal selected from the group comprising Cu, Co, and Mo and/or the granulation aid contains at least one metal sulphate selected from the group comprising zinc sulphate, magnesium sulphate, manganese sulphate, iron sulphate or aluminium sulphate.

29. The method for the production of a fertiliser granulate of claim 28, wherein the granulation aid contains a mixture of iron sulphate and aluminium sulphate.

30. The method for the production of a fertiliser granulate of claim 29, wherein the granulation aid contains a mixture of iron sulphate and aluminium sulphate with an amount of 50% by weight or less of iron sulphate and an amount of 50% by weight or more of aluminium sulphate.

31. The method for the production of a fertiliser granulate of claim 28, wherein a first composition containing at least one granulation aid and/or granulation additive and/or trace element in an aqueous solution and a second composition containing ammonium sulphate in an aqueous solution are produced separately, wherein the first and second compositions are then mixed with each other and the mixture is sprayed in the fluidised-bed granulator.

32. The method for the production of a fertiliser granulate of claim 31, wherein water is further added to the mixture before spraying in the fluidised-bed granulator in order to arrive at a specified solution concentration.

33. The method for the production of a fertiliser granulate of claim 31, wherein ammonium sulphate is further added to the mixture as a solid before spraying in order to arrive at a specified solution concentration and a specified mixing ratio.

34. The method for the production of a fertiliser granulate of claim 28, wherein the aqueous composition is sprayed from below into a fluidised bed of the fluidised-bed granulator.

35. The method for the production of a fertiliser granulate of claim 28, wherein the aqueous composition is sprayed via nozzles at a spray rate of at least about 150 ml/min per nozzle.

36. The method for the production of a fertiliser granulate of claim 28, wherein the granulate is then dried in the fluidised-bed granulator in which it was produced.

37. The method for the production of a fertiliser granulate of claim 36, wherein the granulate is then dried in the fluidised-bed granulator in which it was produced with hot air.

38. A system for the production of a fertiliser granulate based on ammonium sulphate comprising:
a fluidised-bed granulator to which process air is supplied via a line and to which a solution containing ammonium sulphate and granulation additives is supplied, the solution being sprayed into the fluidised bed granulator via a spray nozzle;
wherein the system comprises:
separate first and second vessels, wherein the first vessel is configured to receive a first solution containing granulation additives in water and the second vessel is configured to receive a solution containing ammonium sulphate in water, and wherein the first and second vessels are connected to each other or to a further vessel via a line and at least one of the first and second vessels or the further vessel is directly or indirectly operatively connected to the fluidised-bed granulator via a line.
